(19) United States
(12) Patent Application Publication
(10) Pub. No.: US 2008/0147557 A1
(43) Pub. Date: Jun. 19, 2008

(54) Display based purchase opportunity originating from in-store identification of sound recordings

(76) Inventor: Dennis G. Sheehy, Greenville, DE (US)

Correspondence Address: Rader, Fishman & Grauer PLLC, Suite 501, 1233 20th Street, N.W., Washington, DC, 20036, US

(21) Appl. No.: 11/240,623

(22) Filed: Oct. 3, 2005

(51) Int. Cl. H04L 9/00

(52) U.S. Cl. 705/58

(57) ABSTRACT

An automated system that facilitates the real time identification of sound recordings in a retail environment and concurrent correlation and display for listeners of information such as the title and artist for the sound recording, as well as an accommodation of a purchase opportunity of or related to the sound recording. The system also identifies and reconciles un-matched recordings for improved subsequent matching. The system is retailer-configurable, such that messages and content may be automatically displayed at the same time on point of sale machines or other in-store displays. This allows the proprietor to cross-promote other products and services, as well as the identification of songs other than the currently playing one for the consumer. The consumer may link to systems that allow a purchase of the music in various ways, including downloading of digital files, providing a burned or pre-packaged CD/DVD, and others.

### BACKGROUND OF THE INVENTION

1. Field of the Invention

This invention relates generally to the identification of music, and more particularly to a retail system that promotes the sale of the identified recording and other related products and services at the point of immediate consumer demand.

2. Description of the Related Art

Over the past few years, the music industry has experienced a significant decline in both revenue and unit volume, potentially due to factors such as Internet file sharing, as well as the tendency of an aging population to buy less music. According to a recent study sponsored by the National Association of Recording Merchandisers (NARM), 75% of consumers no longer consider music a “destination buy”, which means that they don't proactively travel to traditional record stores for the express purpose of buying music. It is no longer considered convenient to do so.

It has long been known that consumers have the maximum impulse to buy music immediately after hearing a song, and that, according to Jupiter Research, most of these impulses are triggered by radio, music video, and concerts. The majority of impulses triggered by radio and concerts occur outside the home, while in transit, or in retail and other locations. It has also been recognized for years that many consumers do not know or remember the title or artist of a song being played on their radios or in retail environments, and that any invention or program that facilitates the identification of such songs or artists will help the consumer in the buying process—particularly if such identification occurs at the point where consumers also have the ability to immediately buy the respective recording.

During the 1980's, an industry wide program was promoted by the major Record Labels called “When You Play It, Say It”, to encourage radio DJ's to identify songs that were being played on their respective station. This was deemed a successful promotion, but ultimately lost traction as DJ's generally lost interest due to a lack of incentive for them to continue identifying songs.

Prior art recognition systems have attempted to automate both the identification of sound recordings as well as the purchase of those recordings. One type of system matches sound waves from radio and other broadcast recordings with stored reference signatures, and may also include meta data in relation to the recording signatures (i.e., “fingerprints”). Another type of system identifies songs for the purpose of retrieving musical accompaniment for the consumer to sing to. Finally, some cell phones, computers, and specially equipped radios facilitate the ordering of music and other digital content through recognition schemes that depend on manual intervention and stored play lists or other programming information.

No known recognition and point of sale system, however, provides an integrated functional capability where a song or other audio recording is recognized without knowledge of its source, delivery vehicle, or pre-set play list, and then automatically and in real time triggers the presentation of configurable messages and other content on Point of Sale (POS) machines and other retail displays, and facilitates the physical sale of the song and other promoted content through system direction to a respective part of the store, and/or, downloading, CD/DVD burning, or purchase and storage of the digital content itself. Existing systems also do not provide a method for capturing and remotely processing unmatched local broadcasts with remote reference signatures, and subsequently enabling either the identification of such broadcasts and/or the presentation of exception messaging and content on in-store displays.

### SUMMARY OF THE INVENTION

An automated system that facilitates the real time identification of sound recordings in a retail environment and concurrent correlation and display for listeners of information such as the title and artist for the sound recording, as well as an accommodation of a purchase opportunity of or related to the sound recording. The system also identifies and reconciles un-matched recordings for improved subsequent matching. The system is retailer-configurable, such that messages and content may be automatically displayed at the same time on point of sale machines or other in-store displays. This allows the proprietor to cross-promote other products and services, as well as the identification of songs other than the currently playing one for the consumer. The consumer may link to systems that allow a purchase of the music in various ways, including downloading of digital files, providing a burned or pre-packaged CD/DVD, and others.

In one embodiment provision of a purchase presentation is provided at a point of sale system. The point of sale system receives an audio signal containing a given audio content that is emanating from a sound source that is in a retail environment and that is separate from the point of sale system. To identify the given audio content, the point of sale system then accesses a database containing a plurality of retained audio content references to identify the given audio content. Then a set of meta data that corresponds to the given audio content is identified. The meta data is used to a purchase opportunity display corresponding to the given audio content while the given audio content is emanating from the sound source.

The point of sale system may be configured to retain a local database, but may also be configured to communicate with an external database provided by a matching service, to accommodate identification of content and corresponding identification of meta data for the identified content.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a schematic diagram illustrating a system that integrates identification of sound recordings with external third party services in accordance with an embodiment of the present invention.

FIG. 2 is a block diagram illustrating a system for identification of sound recordings in accordance with the present invention.

FIG. 3 is a block diagram illustrating a system for identification of sound recordings in further detail, along with related databases and interfaces.

FIG. 4A is a display diagram illustrating an embodiment of an interface for in-store management and reporting.

FIG. 4B is a display diagram illustrating an embodiment of an action selection table interface.

FIG. 4C is a schematic diagram illustrating an example of a display database including content triggered by the actions noted in FIG. 4B.

FIG. 4D is a schematic diagram illustrating an example of a store inventory database that identifies the presence of physical inventory and its physical location in the store.

FIG. 4E is a schematic diagram illustrating an example of a database that tracks matched in-store songs by location, time, date, and other parameters for access by any networked location within a local area.

FIG. 5 is a flow chart illustrating an embodiment of fingerprint matching and updating performed by the processing module of FIG. 3.

FIG. 6 is a flow chart illustrating an embodiment of action processing performed by the processing module of FIG. 3.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

The present invention may comprise computer programs, systems, and processes which allow consumers to hear a song or other audio broadcast in any environment where they themselves are not controlling the source of such broadcasts, to view text, video, graphics, or other information on a display that identifies that song's title, artist, and other related content—while the song is still playing—and provides said consumers with the option of immediately purchasing the identified content. The purchase may be made directly or indirectly from the point of sale machine. Indirect purchases may typically be made through other display devices with file downloading capability, or through directions to where the buyer can find the physical CD or other content within the retail location.

According to one aspect, this capability is provided to consumers without requiring manual intervention during the identification and presentation process, and without the need for any other device such as cell phones, portable computers, personal digital assistants, or other currently required means of facilitating sound recognition.

Also provided are the identification, storage, and presentation for later listening and/or purchase, of all music or audio broadcasts played recently on the in-store sound system (i.e., ‘last 3 songs’, ‘last 10 songs’, ‘songs played today’, ‘songs played yesterday’, ‘songs played this week’, etc.), giving the consumer the ability to select and/or purchase music while they are in the store but not necessarily immediately after hearing the recording.

According to another aspect, consumers are provided with the foregoing capability anywhere they have heard a particular song or audio broadcast, assuming that their current location is linked by network or other means to other locations where the recording was initially heard. For example, the system in a local coffee shop may not only identify and store titles and content played within that location, but also lists those songs the consumer may have heard earlier at their local fitness club, grocery store, restaurant, etc.

According to still another aspect, the system facilitates maximum flexibility for the source of the in-store broadcast—be it music from an in store CD player, satellite or terrestrial radio feed, internal music network, internet streaming, or other system, without a pre-determined knowledge of said source.

The system may also implement wireless receivers and transmitters to facilitate maximum flexibility in the placement of either the in-store sound speakers or the kiosks, point of sale machines, displays, or other devices that show the title, artist, or other information related to the audio broadcast.

Preferably, certain embodiments of the invention will make use of sound recognition technology that relies primarily on the audio ‘fingerprint’ of the actual recording, and not necessarily on additional identifiers from legacy inventions that include watermarks, RDS/RBDS data streams, encryption, Artist-Title pair (ATP) tags, or other alphanumeric codes that serve as descriptive metadata for the recordings.

Still another aspect enhances the foregoing capability by automatically providing additional information to third party sound recognition services for the reconciliation of unmatched recordings. Such information could include, but is not necessarily limited to, retailer-configured parameters (e.g., “this store location is usually set to this radio channel during these times”), content-provider parameters (e.g., list of local artists who have performed recently within a 50 mile radius), GPS location identifiers (from the POS kiosk or other display), date/time stamps, or other automatic or retailer-input data that will make it easier for said recognition services to identify the unmatched recording, and automatically update the local audio fingerprint database.

Also facilitated is the speed by which music and other audio broadcasts heard in a local environment are accurately identified and displayed to the consumer. This aspect of the invention is accomplished through software algorithms that cache in local RAM, flash, or other rapid access memory, as well as on local disk-based storage, those audio fingerprints and related display information most likely to be matched with the local in store broadcasts (e.g., a local band in Boston will usually not be heard at an in store environment in Los Angeles—therefore, the system residing in a Boston location would locally store title, artist, fingerprint, and other data for that respective band while the L.A. store would not.).

Preferably, the invention provides the host retailer or proprietor with a system that promotes the in store purchase of music, video, or other digital content, the purchase of physical goods or services, as well as enhancement to the overall brand and customer experience.

Configurable messages, digital content, cross-promotions, and integration with both in store POS systems and displays (such as digital kiosks and digital touch pads), with a retailer's own internet site, and/or with content providers who may deliver additional advertising content along with digital and physical product may further facilitate the ease with which the system may be implemented by retailers.

Preferably, a “Now Playing” feature integrated with POS machines and/or displays, where the consumer is able to identify the title currently being heard in the location regardless of whether or not the retailer has chosen to display such title and other information (i.e., a “Now Playing” button or feature), which allows consumers to identify the title without interruption to video currently being displayed.

Additionally, a “Buy with One Touch” feature integrated with POS machines and/or displays, allows the consumer to listen to and/or purchase the title currently being heard in the location through digital downloading, CD/DVD burning, or storing for future use of the purchased content.

The display may variously be an electronic display, a liquid crystal display, a plasma display, an electronic re-writable paper, a standard television, or another visual medium.

A receiving mechanism may encode and transmit in-store music or other audio broadcasts and filter out ambient environmental noise, by being placed in close, non-feedback producing proximity to the in store speaker system, and/or being attached to the external wire between an in store speaker system and the in store sound source, and/or being directly connected through wired or wireless means to the in store sound source. The placement of the receiving mechanism allows maximum flexibility in the location of either the speaker system and/or the identification module.

The public display of a song's title, artist, label, and other information is preferably started as close to the beginning of the song as possible, and potentially along with other video, announcements, advertising, cross-promotion, and/or other triggered content, which may increase sales of such content or other goods and services made available by the retail establishment. Real time recognition of in store broadcasts along with the capability to purchase and rapidly download such broadcasts and related content onto portable cell phones, MP3, video, and other music and video players in the possession of the consumer, may increase sales of music, video, and other content, improve the overall customer experience of consumers visiting such locations, and increase foot traffic over other locations that do not have this capability. Free ‘promotional’ downloads of music or other audio broadcasts may also improve the overall customer experience and increase sales of other goods and services made available by the establishment.

In its preferred embodiment, this invention is a retail-based system. The retail environment refers to a location outside the home environment arranged for providing goods or services to consumers. The retail environment may alternatively (or also) be a place of congregation. The retail environment is also typically an environment that is conducive to or normally includes the playing of music or other audio broadcast for persons, regardless of the source of the transmission or the genre of music.

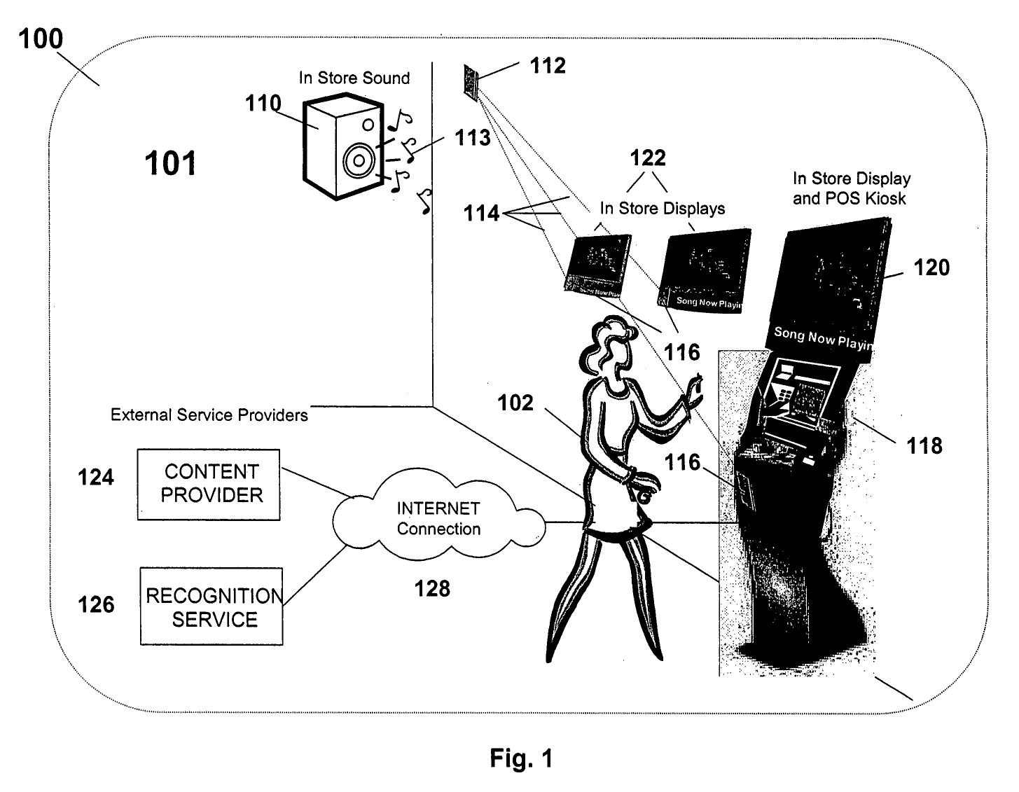

FIG. 1 is a schematic diagram illustrating a system that integrates identification of sound recordings with content providers and a recognition service. In conjunction with recognition of the in-store audio, the system 100 provides real time display of title, artist, and other related data, and an opportunity for convenient purchasing of the respective content.

The system 100 is configured for operation in a retail environment 101, where the consumer 102 would normally be passively exposed to music or other audio broadcasts emitted by an in-store speaker 110. The music 113 may be the original sound emanating from speakers connected to any sound source, including satellite, terrestrial, or Internet radio, CD players, tape decks, internal store stereo channels, etc. The location visitor 102 is not required to have on their possession or at their disposal a cell phone, computer, or any other device to facilitate operation of the system.

The system 100 also includes a wireless sound encoder and transmitter 112 attached or in close proximity to the speaker 110 that will capture the sound waves from speaker 110 and transmit them through wireless 114 means to a receiver 116, which will in turn decode the signal for song matching and identification by a computer-based processing module contained in either POS unit 118 and/or in display units 122.

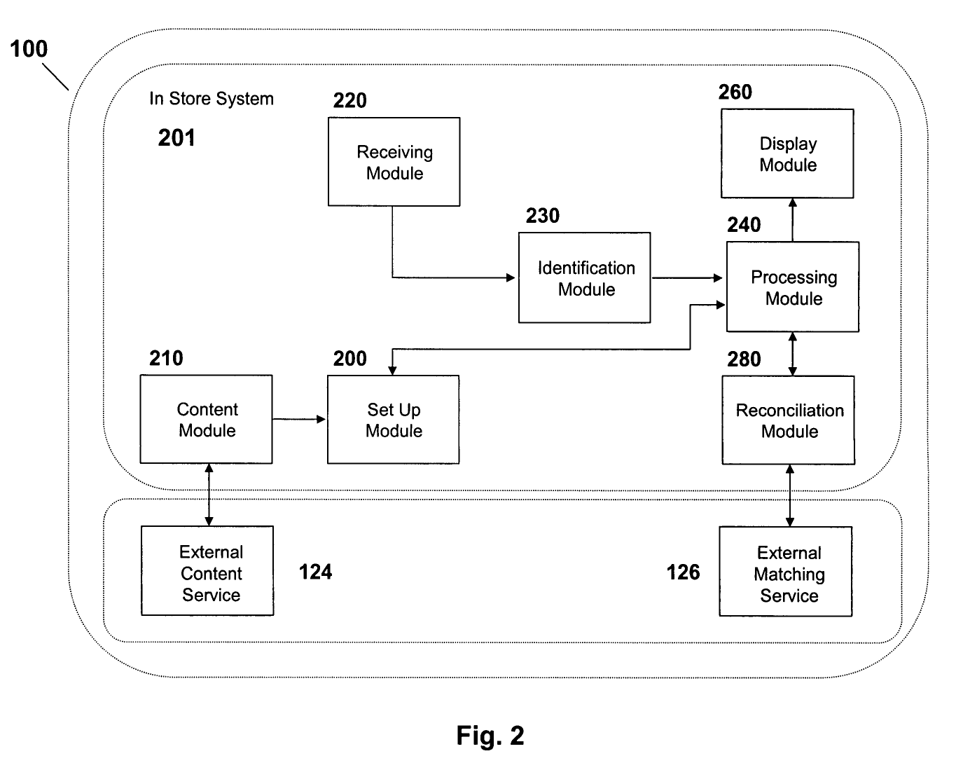

Subsequently the processing module, in conjunction with the display module and reconciliation module described in FIG. 2, will cause system 100 to electronically send data about the title, artist, and/or other configurable messages and content to in-store displays 120 and 122, presenting the consumer with real time information about the song now playing, as well as potentially showing the artist's music video, concert news, store specials, or other configurable content.

Either on an ad hoc or scheduled basis, local databases contained on the computers housed in POS unit 118 and/or display units 122 will be updated through Internet connection 128 by content provider 124 (for the purpose of downloading to the local site product, descriptive, and advertising content), and by recognition service 126 (for the purpose of adding song fingerprints not found on the local site, updating ‘where heard’ databases, and/or reporting statistics back to the retail end point).

As shown in FIG. 2, operation of the present system 100 comprises nine (9) main components, including integration and interfaces with external content provider 124 and external matching service 126. Preferably, the in-store components 201 of the current system are comprised of computer programs, databases, and user interfaces housed either on the computers supporting POS kiosk 118 and/or standalone displays 122. Alternatively, the functionality may be supported by a separate computer system operated by the retailer or by an external service provider.

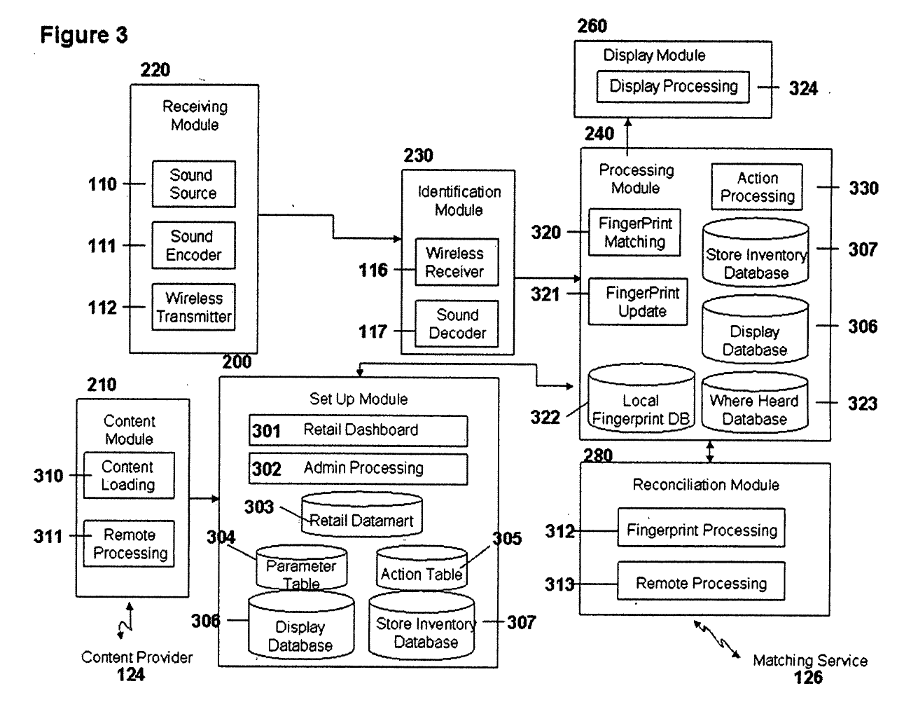

FIG. 3 is a block diagram illustrating a system for identification of sound recordings that facilitates point of sale purchase, along with related databases and interfaces. As described, the system may comprise a processor that executes instructions stored in memory to provide the described functionality. The process for recognizing music and allowing personnel in the host location to customize their sales and marketing around such music begins with set up module 200, which allows designated personnel managing the retail site to review the parameters configured by themselves or other site personnel, view content provided by both outside services and in-store sourcing, and receive statistics on how many songs were played, recognized, physically carried in the store, and/or ultimately bought, as well as other statistics determined in conjunction with the outside services.

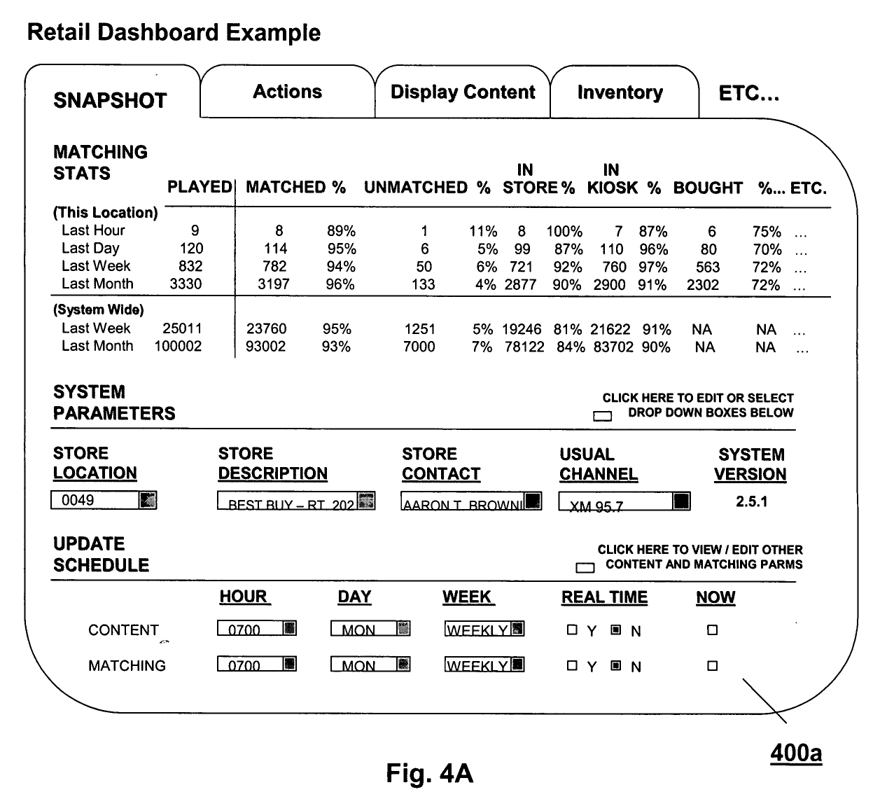

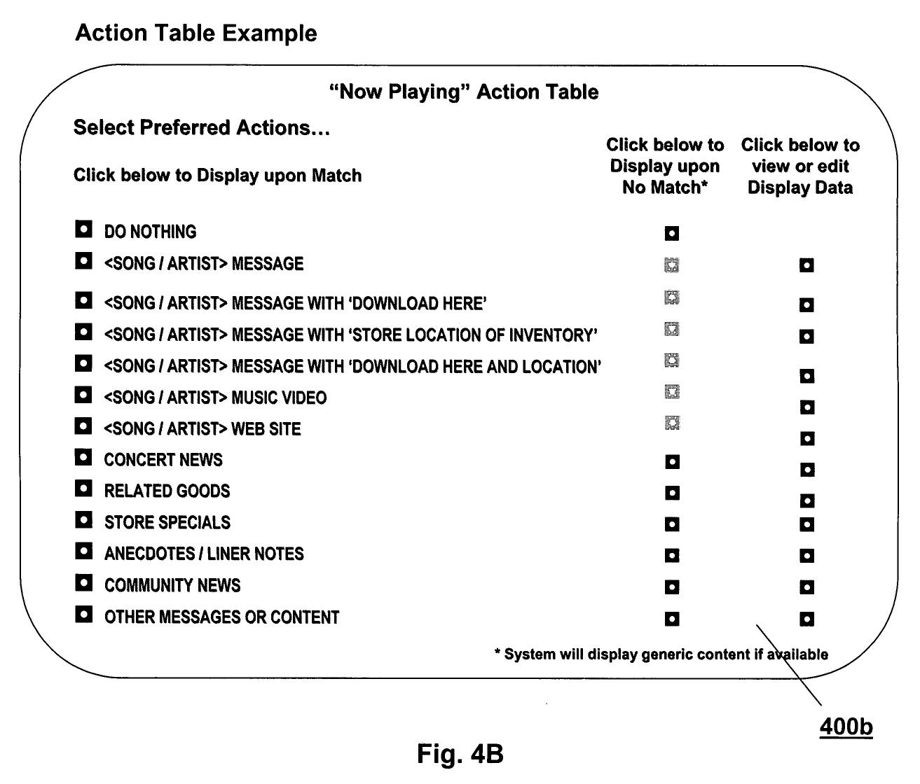

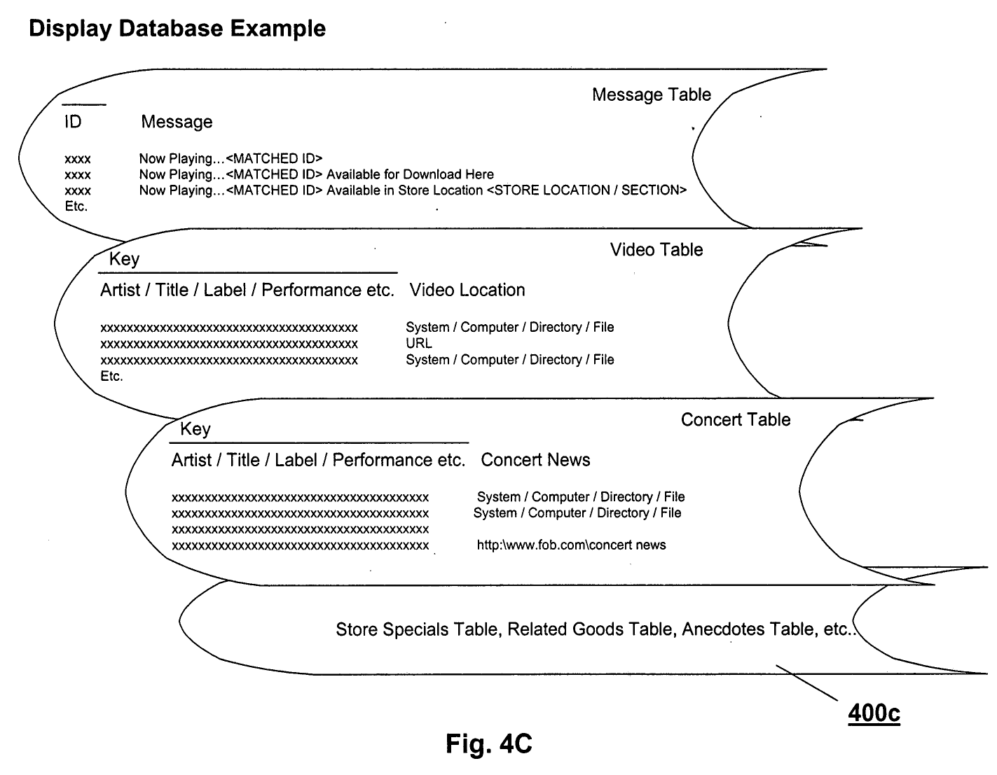

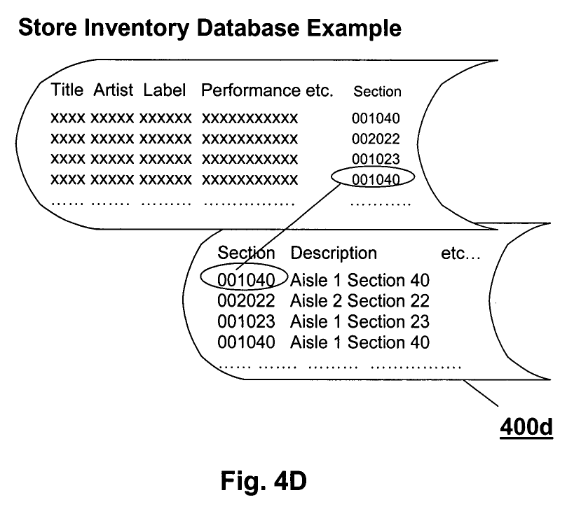

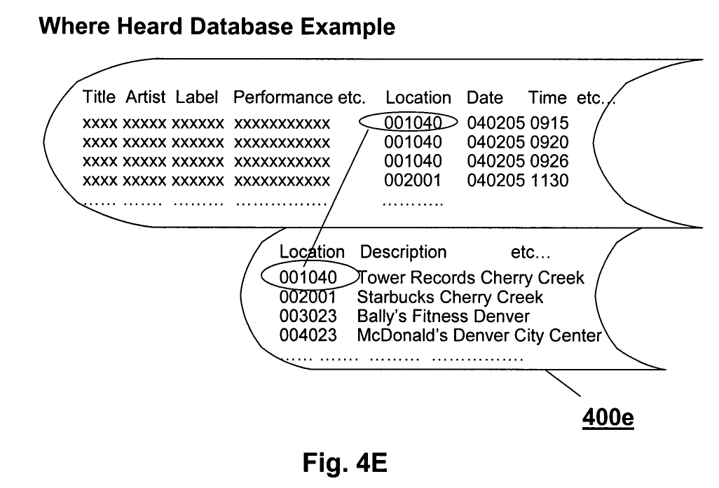

The management data is loaded into retail data mart 303 and presented through the retail dashboard 301, which communicates with the parameter table 304, action table 305, display database 306, and store inventory database 307 to accommodate population of the system with various information. The parameter table 304 contains configurable parameters such as store location, ‘normal’ audio source, and timing of outside service requests. The action table 305 contains the options for what actions to take upon either song recognition or lack thereof. The display database 306 contains the actual messages, video content, Internet links, or other items actually displayed upon taking a particular action, and the store inventory database 307 contains titles physically carried by the retailer along with their respective physical location in the store. Examples of the retail dashboard 301, parameter table 304, action table 305, display database 306, and store inventory database 307 are depicted in FIG. 4A, FIG. 4B, FIG. 4C, FIG. 4D, and FIG. 4E, respectively.

Particularly, FIG. 4A illustrates an interface 400a for in-store management and reporting. FIG. 4B illustrates an action selection table interface 400b. FIG. 4C illustrates a display database 400c including content triggered by the actions noted in FIG. 4B. FIG. 4D illustrates an example of a store inventory database 400d that identifies the presence of physical inventory and its physical location in the store. FIG. 4E illustrates an example of a database 400e that tracks matched in-store songs by location, time, date, and other parameters for access by any networked location within a local area. The examples are considered to be illustrative, and the system designer may elect to include more or different data than shown in the examples, as desired.

Retail personnel may use admin processing functionality 302 in module 200 to input and edit parameters, desired actions, displayed content, and inventory items into their respective tables and databases, as well as to request content loading or other remote processing from module 210, and to request fingerprint processing and other remote processing (usually management reporting data) from reconciliation module 280.

Referring to content module 210 in FIG. 3, content loading 310 and remote processing 311 act in concert as a staging process for obtaining music content, video, graphics, metadata, or other content transmitted over the Internet by content provider 124 either at the request of admin processing 302 or on a scheduled basis per parameter table 304.

Referring to reconciliation module 280 in FIG. 3, fingerprint processing 312 and remote processing 313 act in concert as a staging process for synchronizing local fingerprint database 322 with fingerprint databases residing with matching service 126, and to update the where heard database 323 with song titles, artists, dates, and times played from other local establishments. The preferred embodiment of this process occurs in real time over the Internet and is further described under the description for processing module 240.

Once the system has been initiated through set up module 200, and subsequent content and fingerprint downloads through 210 and 280 have populated local databases, receiving module 220 is ready to capture in-store sound for matching, identification, and action processing.

As shown in FIG. 3, the preferred embodiment of this invention includes an in-store sound source 110 of any kind, along with a sound encoder 111 and wireless transmitter 112 physically placed on or around the sound source. For the purpose of the present invention, ‘sound source’ describes a speaker or other broadcast medium, but as noted below in alternative embodiments, may be a direct output from sources such as a stereo, radio, or Internet receiver.

Sound encoder 111 may or may not be imbedded in wireless transmitter 112, and is intended to encrypt, compress, or otherwise prepare the sound waves coming from the source speaker for direct wireless transmission from transmitter 112 to wireless receiver 116. This aspect of the present invention is intended to screen out ambient noise in the retail environment that may prevent the system from recognizing the aural signatures of in-store broadcasts. The actual placement or use of sound encoder 111 and wireless transmitter 112 will be dependent on the physics of known feedback and signal distortion impacts (i.e., receivers placed too close to the speaker may cause audio feedback and signal distortion. This can be addressed through placement or alternative embodiments as noted below.)

There are other embodiments that may prove effective and pre-empt or modify the receiving and identification process. One alternative embodiment may include wire transfer of audio signals from the source system through a port in the stereo, radio, or computer receiver, directly to the computer housing fingerprint matching module 320. Another alternative embodiment may be the attachment of the encoder/receiver to wires leading to the in-store speakers, and using existing technology to ‘read’ the audio signals through the wires without physically interrupting the flow of such signals. Still another alternative is Holosonic Research Labs' Audio Spotlight processor and transducer (U.S. Pat. Nos. 6,661,285, 6,771,785, 6,775,388, 6,914,991). Yet another alternative is usage of MusicID™ service as developed by Gracenote, to match streamed and recorded sound with its respective fingerprint with enough precision necessary to eliminate or modify the need for an external receiving module.

In this fashion, the identification module 230 captures the encoded sound waves through wireless receiver 116, and uses sound decoder 117 to present the directed in-store music in a format recognized by processing module 240.

Referring to FIG. 3, processing module 240 subsequently performs the main matching, action processing, and database updating for the recognition, presentation, and point of sale aspects of the present invention.

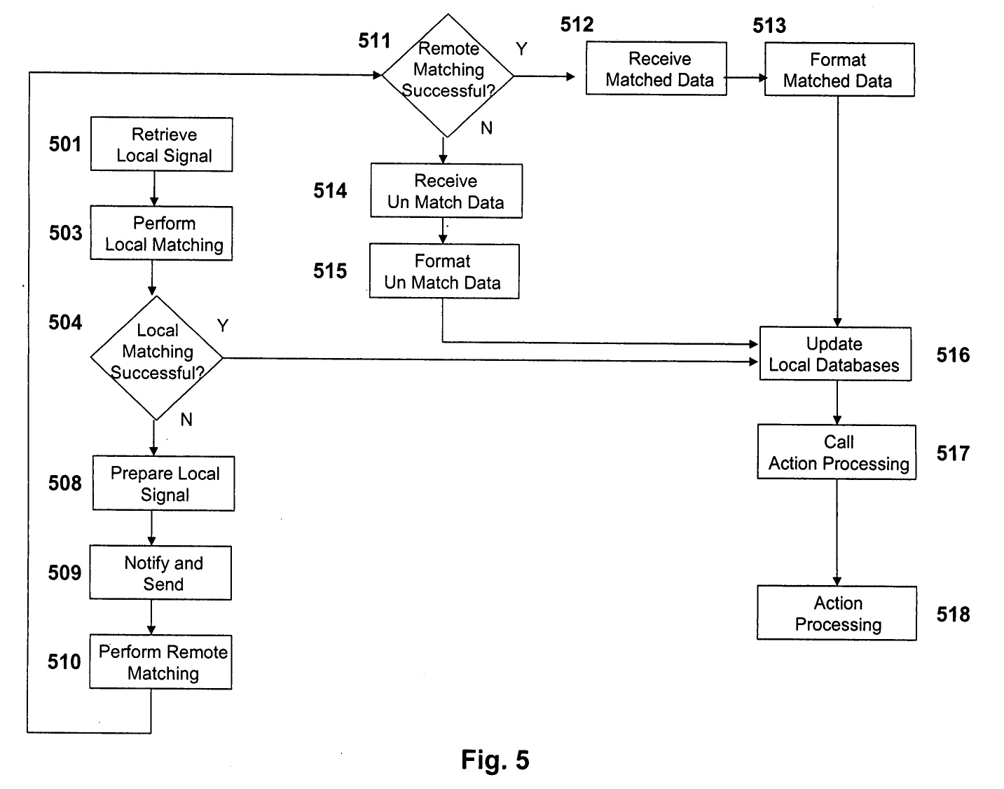

Referring to FIG. 5, the logic flow of the fingerprint retrieval, matching, updating, and exception handling process is as follows: In step 501, the system retrieves the in-store signal from identification module 230 and accesses the local fingerprint database 322, performing local matching process 503. Note that local fingerprint database 322 includes audio reference signatures compiled specifically for that location, as described previously. It also includes all of the relevant metadata for those respective signatures. The reference signature and its metadata comprise the audio ‘fingerprint’. If step 504 of the local matching process 503 returns a positive result, the system then performs step 516, using fingerprint update component 321 to update statistics in retail data mart 303, update where heard database 323, and call action processing component 330—providing title/artist, time/date, location, and other data for further processing by component 330.

If step 504 of the local matching process 503 returns a negative result, the system then prepares a copy of the local signal in step 508 and transmits of copy of the unmatched local signal in step 509, along with other relevant data. (This other relevant data may, but not necessarily, include RDS/RBDS (Radio Data Systems/Radio Broadcast Data Systems) information, ATP (artist/title pair) tags, watermarks, or other data easily captured by the system from the in-store transmission. This additional data is useful in that it makes it easier for the external matching service to determine the title, artist, and other metadata for the unmatched broadcast.

In step 510, the matching service 126 then attempts to match the copy of the local signal with its resident fingerprint libraries. If this remote matching step 511 returns a positive result, the system then performs steps 512 and 513 respectively to accept the positive match data and format it for step 516 update of local databases, including the retail data mart 303 (for statistics), where heard database 323 (which tracks songs that have been played by location), and the local fingerprint database 322 (to add the new reference fingerprint and its accompanying meta data to the local site). The system then sequentially or in parallel to the above steps performs step 517 to call the action processing component 330 in step 518, providing title/artist, time/date, location, and other data for further processing by component 330.

If remote matching step 511 returns a negative result, the system performs steps 514 and 515 respectively to accept and format data reflecting an unsuccessful match to the in-store broadcast, and updates local databases accordingly in step 516. (This update process performed by fingerprint update component 321 includes updates to the retail data mart 303 for reporting on unmatched songs, as well as writing of the unmatched signal pattern to the local fingerprint database 322 for potential later processing by the remote matching service.) Fingerprint update component 321 then performs step 517 to call action processing component 330 in step 518—in this case providing the action processing component with results that trigger exception processing by component 330.

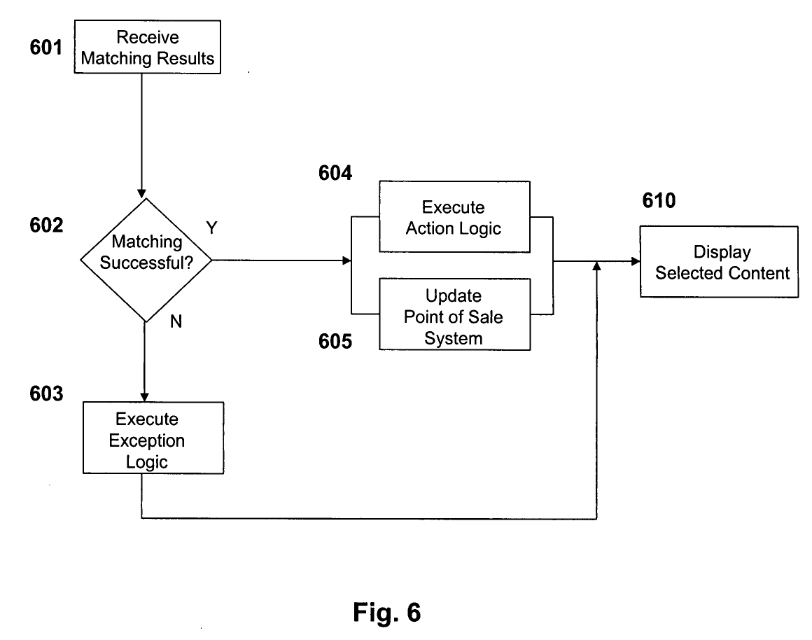

Referring to FIG. 6 along with FIG. 3, action processing component 330 accepts the matching results in step 601 from the fingerprint matching and update process. If step 602 returns a positive result, the system executes action logic in step 604 and point of sale updates in step 605. In the preferred embodiment, step 604 action logic includes, but is not limited to, presenting selected messages and content in step 610 to the display module 260 for display processing 324 (FIG. 3)—based upon options selected on the “Now Playing” Action Table (FIG. 4B). For example, if the in-store broadcast has triggered a successful identification of the title, artist, performance, etc., the retailer may have configured the system through admin processing 302 (FIG. 3) to display a ‘Now Playing’ message with the respective title and artist names, and to retrieve, if available, the respective music video for display at the same time. Step 605 update of the point of sale system would include a refresh of the point of sale screens that list the additional ‘where heard’ title now playing, as well as checking in-store inventory database 307 to determine if the title is physically available at the respective location, and if so, displaying a message through step 610 to that effect. For the purpose of this invention in-store displays 122 and 120 (from FIG. 1) that present the messages processed through step 610 are assumed to be standard television monitors, flat screen liquid crystal displays, flat screen plasma displays, electronic reusable paper using transparent thin film transistors—as developed by Xerox, Fujitsu, E-Ink, and others, and/or any other electronic display mechanism. Furthermore, there are numerous combinations of text, video, graphics, and other displayed content triggered by the retailer's configuration and the results of the matching process—all of which comprise alternative embodiments of the present invention.

If step 602 in FIG. 5 returns a negative result, the action processing component executes exception logic in step 603, again determined by a combination of options selected on the Action Table (FIG. 4B), internal exception logic, and records in the Display database (FIG. 4C) that represent generic content displayed if no matches are found.

Thus embodiments of the present invention produce and provide in-store identification of audio recordings for purchase presentation. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. For use in a point of sale system, a method for providing a purchase presentation for identified audio content, the method comprising:
receiving at the point of sale system an audio signal containing a given audio content that is emanating from a sound source that is in a retail environment and that is separate from the point of sale system;
accessing by the point of sale system a database containing a plurality of retained audio content references to identify the given audio content;
identifying a set of meta data corresponding to the given audio content following identification of the given audio content; and
using, by the point of sale system, the set of meta data to generate a purchase opportunity display corresponding to the given audio content while the given audio content is emanating from the sound source.

2. The method of claim 1, wherein the purchase opportunity display includes display elements that accommodate purchasing the given audio content at the location of the purchase opportunity display.

3. The method of claim 1, wherein each of the plurality of retained audio content references comprises a unique fingerprint respectively corresponding to particular audio content.

4. The method of claim 1, wherein identifying the set of meta data comprises communicating with an external matching service that retrieves and returns the set of meta data corresponding to the given audio content.

5. The method of claim 1, wherein the set of meta data includes an artist, title, and label for the given audio content.

6. The method of claim 1, wherein the purchase opportunity display is generated within approximately ten seconds from the start of a commencement of the emanation of the given audio content from the in-store sound source.

7. The method of claim 1, where the point of sale system accommodates initiation by a user of the identification of the given audio content and generation of the purchase opportunity display.

8. The method of claim 1, where the purchase opportunity display comprises an option for initiating an immediate purchase of a title for the given audio content.

9. The method of claim 1, where identification of the set of meta data is conveyed at another point of sale system residing in a different environment, accommodating a review of audio content that was played in the retail environment.

10. The method of claim 1, wherein the set of meta data is retained for a predetermined amount of time, to accommodate an initiation of a purchase of a title corresponding to the given audio content following a termination of the emanation of the given audio content from the in-store sound source.

11. The method of claim 1, wherein the purchase opportunity display identifies a physical location of in-store inventory corresponding to the given audio content.

12. The method of claim 1, wherein the purchase opportunity display identifies an opportunity to order for subsequent delivery an item corresponding to the given audio content that is determined not to be physically carried in-store at the time.

13. The method of claim 1, wherein a subset of the plurality of retained audio content references are retained in a local database upon determining a likelihood that the corresponding audio content will be referenced in-store.

14. The method of claim 13, wherein determining the likelihood entails an examination of those titles expected to have a substantial chance of being played in the location of the in-store site.

15. The method of claim 1, wherein a GPS mechanism within the point of sale system is used to automatically identify an exact location of where a broadcast is heard.

16. The method of claim 15, wherein said exact location is provided to outside services to facilitate at least one of remote audio matching, content loading, or management reporting

17. The method of claim 1, wherein the elements of the purchase opportunity display are customizable by administrative retail personnel.

18. The method of claim 1, wherein retail or other in house personnel may load or configure the content displayed upon such actions as of a result of the matching process.

19. The method of claim 1, wherein retail or other in house personnel may configure other in-store systems for direct interface and loading of data into the present system.

20. The method of claim 19, wherein said data may comprise store inventory data, local audio content, store advertising content, and other configurable data.

21. The method of claim 1, wherein retail or other in house personnel receive information on system parameters, content, matching statistics, and other items of interest.

22. The method of claim 21, wherein said information is obtained real time through a retail dashboard portal or through a management reporting mechanism.

23. The method of claim 1, wherein retailers or other proprietors may use the configurable actions, parameters, display content, and interfaces to promote the purchase of related or unrelated goods.

24. The method of claim 1, wherein an outside matching service provides remote processing for locally heard broadcasts.

25. The method of claim 1, wherein the system provides an outside matching service with additional data to facilitate matching of local broadcasts, including location, RBDS/RDS data, Artist/Title Pair tags, or other metadata not directly included in reference content.

26. The method of claim 1, wherein an outside matching service returns matched audio fingerprints to be stored on at least one local fingerprint database on at least one computer readable medium.

27. A system for providing a purchase presentation for identified audio content, the system comprising:
means for receiving an audio signal containing a given audio content that is emanating from a sound source that is in a retail environment and that is separate from the point of sale system;
means for accessing a database containing a plurality of retained audio content references to identify the given audio content;
means for identifying a set of meta data corresponding to the given audio content following identification of the given audio content; and
means for using the set of meta data to generate a purchase opportunity display corresponding to the given audio content while the given audio content is emanating from the sound source.

28. An apparatus for providing a purchase presentation for identified audio content, the apparatus comprising:
a receiving module, which receives an audio signal containing a given audio content that is emanating from a sound source that is in a retail environment and that is separate from the point of sale system; and
a processing module, in communication with the receiving module, which accesses a database containing a plurality of retained audio content references to identify the given audio content, identifies a set of meta data corresponding to the given audio content following identification of the given audio content, and uses the set of meta data to generate a purchase opportunity display corresponding to the given audio content while the given audio content is emanating from the sound source.

29. The apparatus of claim 28, further comprising:
a reconciliation module, in communication with the processing module, which communicates with an external matching service to identify the given audio content and update the database where an initial access of the database does not identify the given audio content.

30. The apparatus of claim 28, further comprising:
a set up module, in communication with the processing module, which accommodates customization of the elements of the purchase opportunity display by administrative personnel.
